(19) United States
(12) Patent Application Publication
(10) Pub. No.: US 2025/0326150 A1
(43) Pub. Date: Oct. 23, 2025

(54) AUTOMATIC FLAT-PIECE CUTTING MACHINE AND RELATED METHOD

(71) Applicant: FK GROUP S.P.A., Dalmine (Bergamo) (IT)

(72) Inventors: Manuel PASINI, Dalmine (Bergamo) (IT); Sergio GORI, Dalmine (Bergamo) (IT); Paolo CATTINI, Dalmine (Bergamo) (IT)

(21) Appl. No.: 18/873,380

(22) PCT Filed: Jun. 19, 2023
(86) PCT No.: PCT/IB2023/056326

§ 371 Date: Dec. 10, 2024

(30) Foreign Application Priority Data
Jun. 21, 2022 (IT) 102022000013096

(51) Int. Cl. B26D 1/60; B26D 3/10; B26D 5/00; B26D 5/08; B26D 7/06; B26D 7/18; B26D 9/00; B26F 1/16; B26F 1/38

(52) U.S. Cl. CPC B26D 1/605; B26D 5/005; B26D 5/086; B26D 7/1818; B26D 9/00; B26F 1/382; B26D 3/10; B26D 7/0625; B26F 1/16

(57) ABSTRACT

The present invention pertains to a cutting machine for the automated cutting of at least one flat piece of deformable material. The machine comprises a cutting table which supports a cutting mat, a cutting unit provided with a blade and movable above the cutting mat to cut the flat piece into shapes and/or along lines according to a predetermined cutting path, an accessory processing unit provided with at least one accessory tool and movable over at least a portion of the cutting mat to perform accessory processing of the flat piece according to a predetermined accessory processing path, and an electronic control unit that controls the cutting unit and the accessory processing unit so as to actuate the accessory processing unit simultaneously to the cutting unit at least during a cutting step of the flat piece.

### DESCRIPTION

The present invention relates to the field of machines for the automatic cutting of flat pieces made of deformable materials, particularly textiles.

The cutting machines to which the present invention refers are of the type that, by importing via software a cutting path (called “nesting” in jargon), provides for the blade cutting of shapes or along lines, such as, for example, portions of the flat piece defined by polygons. In addition to cutting, these machines may carry out accessory processing, such as, for example, drilling or die cutting of holes, even of different sizes, or labeling the cut portions of the flat piece.

Therefore, in some known embodiments, an automatic cutting machine of the type mentioned above comprises a cutting table which supports a cutting mat and which extends between an area for loading the flat piece onto the cutting mat and an area for unloading the flat piece from the cutting mat. The cutting mat also acts as a conveyor belt and is therefore translatable on the cutting table to transport the flat piece from the loading area to the unloading area.

The machine is equipped with a cutting unit that has a blade or knife and is movable above the cutting mat to perform flat piece cutting in closed shapes or other figures, such as simple cutting along lines, according to a predetermined cutting path. For example, the cutting unit is mounted on a beam which is slidable along the advancement direction of the cutting mat. The cutting unit is also slidable along the beam and therefore orthogonally to the advancement direction of the cutting mat. In this way, the cutting blade may reach any position in the plane defined by the cutting mat.

In the automotive, aerospace, apparel, and composite materials sectors, it is common to use very long nestings (e.g., 10-12 m), in which there are also numerous holes, with diameters that may vary from 1 to 30 mm, for example. The holes are needed to fix, for example by means of clips, the cut materials to the supporting structures of a finished product.

For example, in an automobile, the soft lining parts of an engine hood or luggage compartment are attached to the metal structure with buttons and clips that engage these holes; some deformable components of headrests also need to have holes as circular references for matching them to the upholstery parts, paddings, etc.

Currently, in order to drill these holes during the work cycle of an automatic cutting machine, it is necessary to install on board the cutting head beam one or more devices, such as drills and/or dies, with diameters which are consistent with the size of the holes.

During the work cycle, the material is advanced by the cutting mat (continuously or stepwise), and the material is alternately blade or cut by the drilled/pierced by the drill/die.

The alternative use of the blade or drill/die results from the coexistence of the two devices on the same beam, and this inevitably introduces dead time that slows down the work cycle. For example, the greater the length of the nestings, the more holes with different diameters, the more the whole process suffers downtime due to the alternation between cutting and drilling.

The object of the present invention is to resolve the aforementioned limitations of the textile cutting machine according to the prior art, and in particular it is to propose a flat-piece cutting machine capable of cutting down dead time and reducing the travel time of the flat piece on the cutting table, with obvious advantages in terms of work cycle productivity.

This object is achieved with an automatic flat piece cutting machine according to claim 1 and with a method according to claim 10. The dependent claims describe preferred or advantageous embodiments of the invention.

The features and advantages of the machine and method according to the invention shall be made readily apparent from the following description of preferred example embodiments thereof, provided purely by way of non-limiting example, with reference to the accompanying figures, wherein:

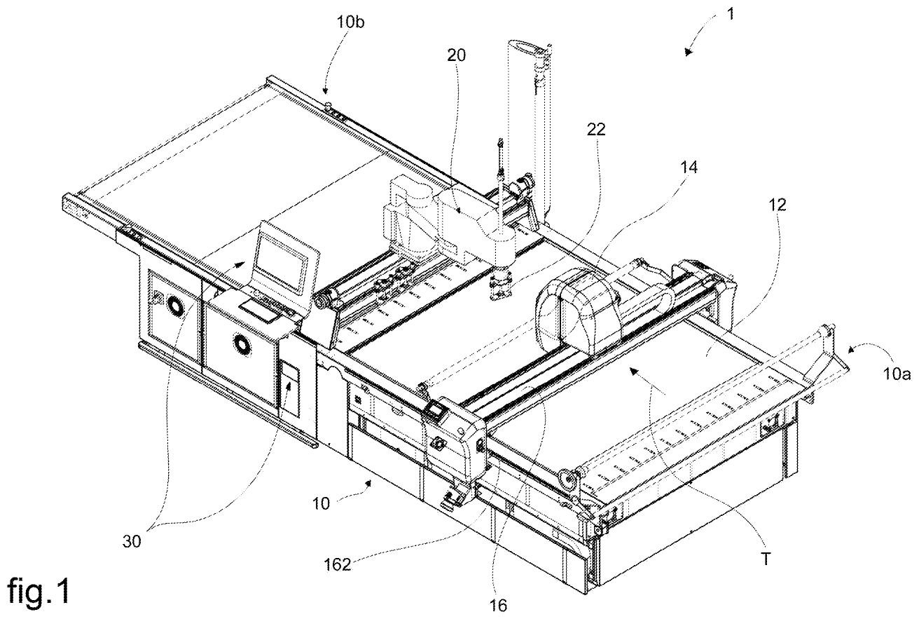

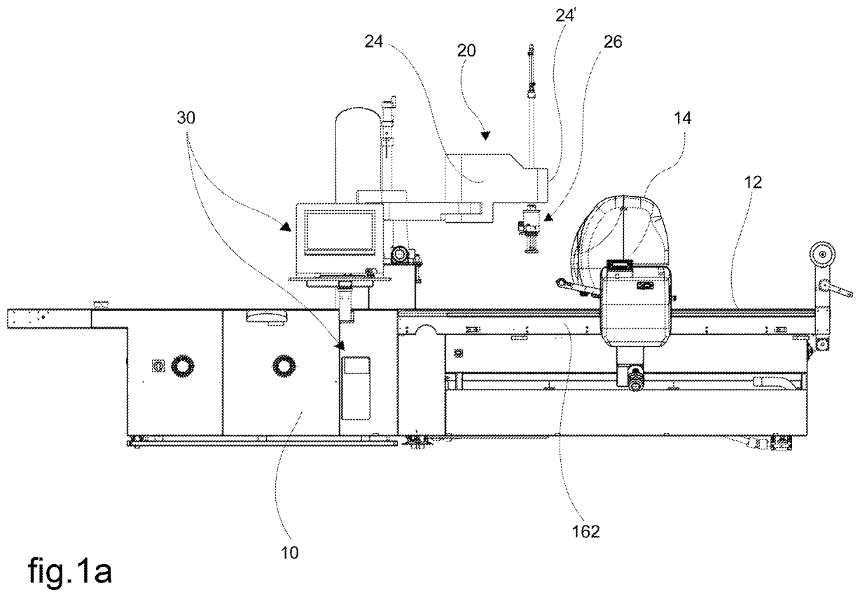

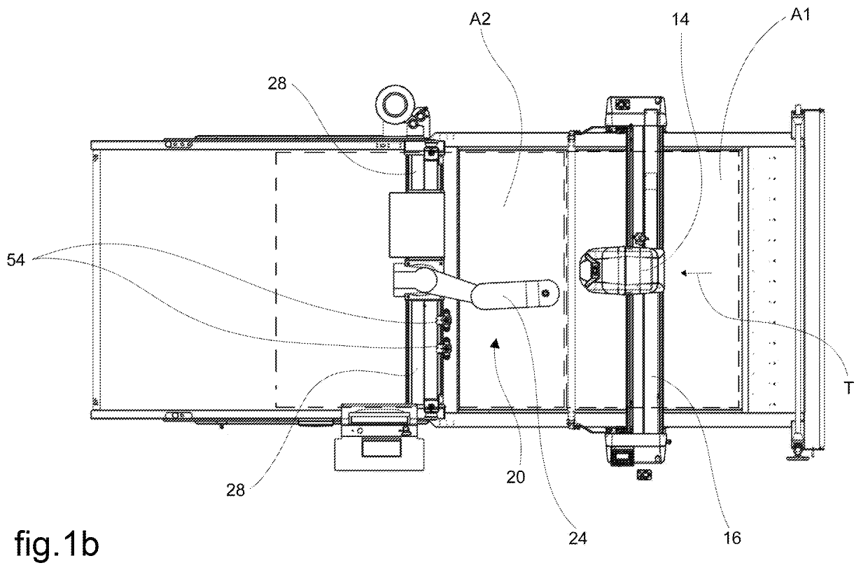

FIG. 1 is a perspective view of a cutting machine according to the invention, in one embodiment;

FIG. 1a is an elevation view of the machine in FIG. 1;

FIG. 1b is a plan view from the top of the machine in FIG. 1, wherein two different work areas are denoted with dashed lines;

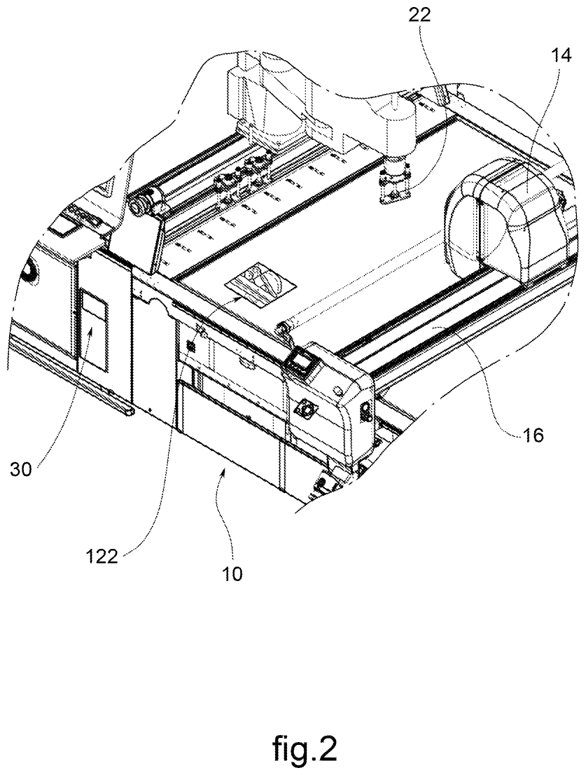

FIG. 2 is a perspective view of a portion of the machine from the previous figures, showing, below the cutting mat, a sensor for detecting the translation of the cutting mat;

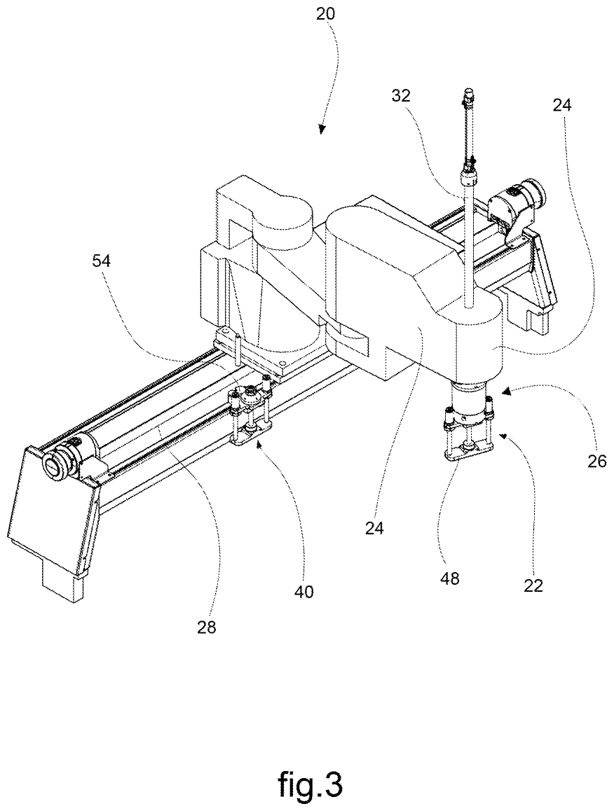

FIG. 3 is a perspective view of only the drilling and/or die cutting unit of the machine in FIG. 1;

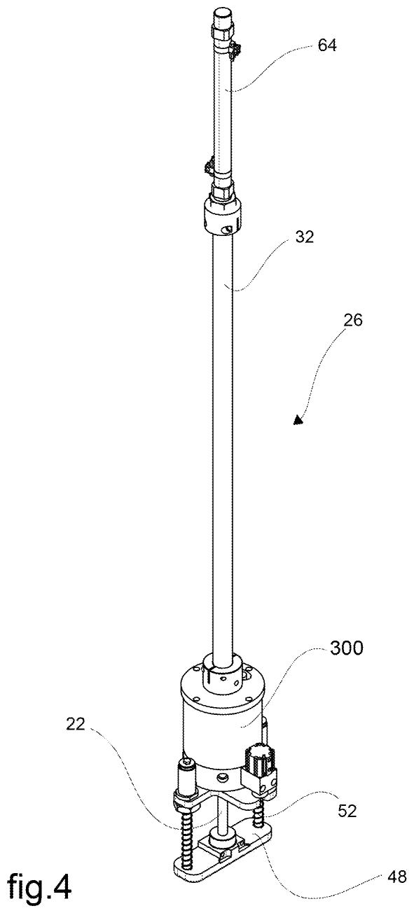

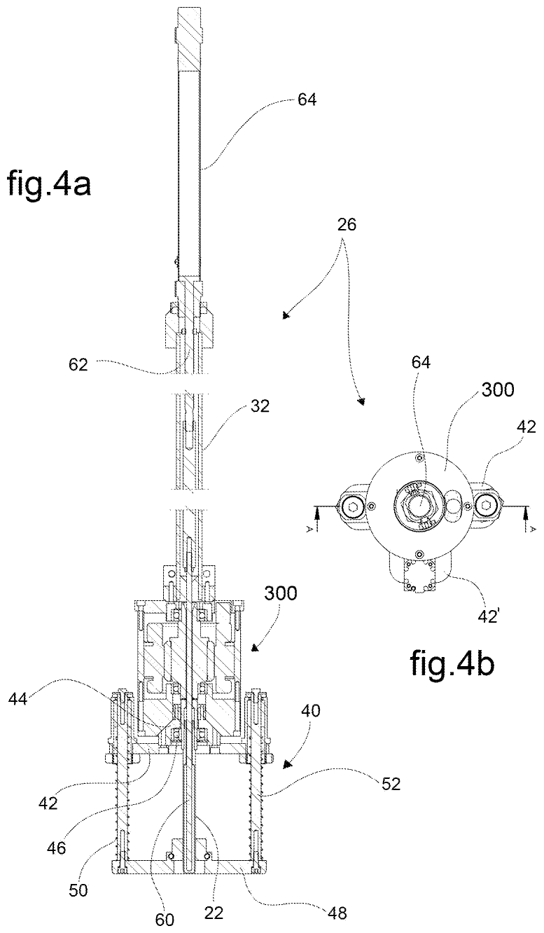

FIG. 4 is a perspective view of an electromechanical member of the drilling and/or die cutting unit in FIG. 3, on which a die cutting tool is mounted;

FIG. 4a is a plan view from above of the electromechanical member in FIG. 4;

FIG. 4b is an axial section of the electromechanical member and the die cutting tool thereof;

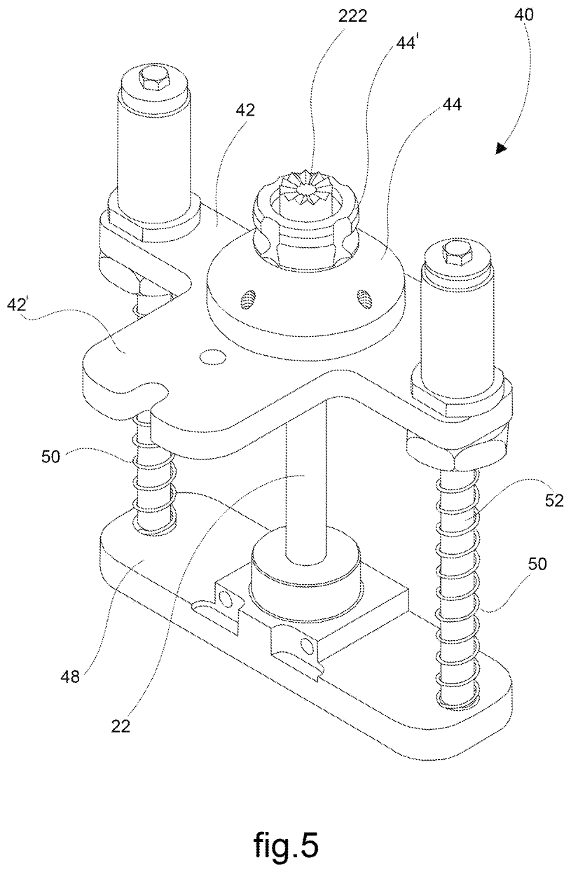

FIG. 5 is a perspective view of the die cutting tool alone, in one embodiment; and

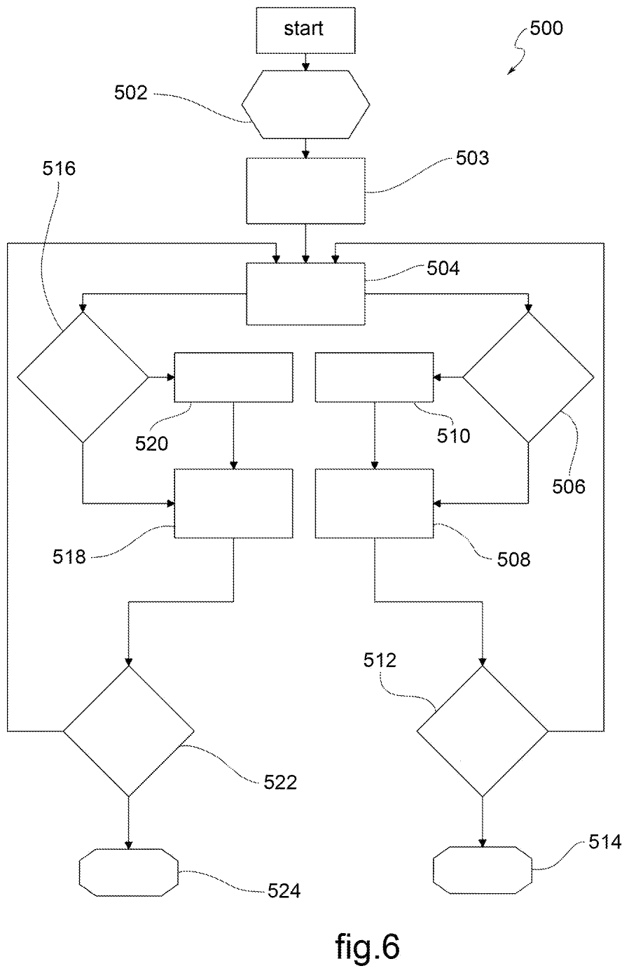

FIG. 6 is a flowchart related to an example of a control program of the cutting unit and of the robot performing accessory processing.

In said drawings, 1 has been used to denote, as a whole, a machine for the automatic cutting of flat pieces made of deformable particularly, but not exclusively, textiles.

The cutting machine 1 is able to process a single flat piece (single-ply machine in the case of textiles) or a plurality of superimposed flat pieces (multiple-ply stack in the case of textiles). In the latter case, the processing units below described are able to simultaneously process all the superimposed flat pieces (the stack) as if they were a single piece. In the remainder of the description, for ease of explanation, the term “flat piece” will therefore be used both to refer to a single flat element and to refer to several flat elements superimposed to form a stack.

The machine 1 comprises a cutting table 10 that supports a cutting mat 12. The cutting table 10 extends between a loading area 10a of the flat piece onto the cutting mat 12 and an unloading area 10b of the flat piece from the cutting mat 12.

The cutting mat 12 is made, for example, as a needle mat or of a felt-like material that specifically allows a cutting blade to pass through. Moreover, the cutting mat 12 may be equipped with piece clamping means, such as suction means, suitable for clamping the flat piece on the surface of the cutting mat 12.

In one embodiment, the cutting mat 12 is translatable on the cutting table 10 to transport the flat piece from the loading area 10a to the unloading area 10b (see arrow T in FIGS. 1 and 1b). In the figures, X denotes the translation axis of the cutting mat. For example, the cutting mat 12 is movable as a conveyor belt (or several adjacent conveyor belts) and is therefore wrapped around two (or more) drive rollers placed at least at the loading area 10a and the unloading area 10b.

The machine 1 is equipped with a cutting unit 14. This cutting unit 14 is equipped with a blade, or knife. The blade or knife may be fixed, such as in the case of single-ply cutting, or adapted to be moved vertically to perform flat piece cutting, such as in the case of multi-ply textiles.

The cutting unit 14 may be of the type conventionally used for these automatic textile cutting machines, and therefore its structure and operation are known to the person skilled in the art and require no further description. An example of a cutting head is described in WO2014064568A2, in the name of the same Applicant.

The cutting unit 14 is movable over a first area A1 of the cutting mat 12 (see FIG. 1b) to perform flat piece cutting according to a predetermined cutting path. The coordinates of the predetermined cutting path (xᵢ, yᵢ, zᵢ) therefore refer to this first area A1 of the cutting mat. For example, the coordinates of the cutting path are calculated relative to a reference point of the first area A1, for example coinciding with a vertex of that first area A1.

In one embodiment, the first area A1 corresponds to the whole area of the cutting machine engaged by the cutting mat 12.

In one embodiment, the cutting unit 14 is mounted on a beam 16 that extends over the cutting table 10 perpendicular to the advancement direction (T) of the cutting mat 12 and is slidable along side guides 162 of the cutting table 10, which side guides extend parallel to the advancement direction of the cutting mat 12.

The cutting unit 14 is also slidable along the beam 16. Therefore, the blade may reach any position in the plane defined by the first area A1.

The machine 1 is also equipped with at least one accessory processing unit 20 suitable for performing additional processing on the flat piece in addition to cutting. As will be described later in more detail, the accessory processing may be drilling or die cutting of the flat piece or labeling of the polygonal portions obtained from the cutting operation.

In a general embodiment, the accessory processing unit 20 is equipped with at least one accessory tool 22 and is movable over a second area A2 of the cutting mat 12. The accessory processing unit 20 is suitable for performing the accessory processing of the flat piece according to a predetermined accessory processing path.

In one embodiment, the second area A2 coincides with the first area A1 and may therefore correspond to the area of the cutting machine engaged by the cutting mat 12.

In a variant embodiment, the second area A2 is an area within the area A1.

In a variant embodiment, the second area A2 is at least partially separate from the first area A1.

In an embodiment shown in FIG. 1b, the first area A1 and the second area A2 are two separate areas adjacent to each other.

The coordinates of the predetermined accessory processing path (xⱼ, yⱼ, zⱼ) may thus refer to the second area A2 of the cutting mat 12.

It should be noted that if the cutting mat 12 is a movable conveyor for transporting the flat piece, the first and second areas A1, A2 of the cutting mat 12 do not necessarily mean physical portions of the cutting mat 12, but rather portions of the surface of the cutting table 10 engaged by the side of the cutting mat facing outward, i.e., upward. If, on the other hand, the cutting machine 1 operates with a fixed cutting mat 12 and the flat piece is advanced along the cutting mat 12 by other handling means, then these first and second areas A1, A2 may also be considered portions of the cutting mat 12.

In one embodiment, the accessory processing unit 20 is movable above the second area A2 independently of the movement of the cutting unit 14 over the first area A1.

However, the accessory processing unit 20 is a separate unit from the cutting unit 14, i.e., it is placed on a support structure separate from the one supporting the cutting unit 14.

The cutting unit 14 and the accessory processing unit 20 are controlled by an electronic control unit 30. In some embodiments, the electronic control unit 30 comprises a cutting unit controller, such as a CNC, and an accessory processing controller, which controls the accessory processing unit 20. If separate, these controllers may still be operationally linked to each other, for example by a communication bus, so that synchronization between the processing steps and/or between the movements performed by the cutting unit and the accessory processing unit may be achieved.

The electronic control unit 30 is programmed so as to actuate the accessory processing unit 20 simultaneously to the cutting unit 14 at least during a cutting step of the flat piece.

In the case of at least partially separate first and second areas A1, A2, the electronic control unit 30 is programmed to actuate the accessory processing unit 20 when the flat piece at least partially enters the second area A2 of the cutting mat 12.

In the case of first and second areas A1, A2 coinciding with each other, the electronic control unit 30 is programmed to manage the operations of the cutting unit 14 and the accessory processing unit 20 in such a way that the two units may operate simultaneously but without interfering with each other.

Therefore, the two processes may take place simultaneously during one stage of the (at least machine's work cycle), i.e., in parallel, rather than alternately with each other as in current machines. The simultaneous operation of the cutting unit and the accessory processing unit within the work cycle of the material results in a reduction in downtime and less time spent traversing the material to be cut and drilled (or to be subjected to other processing), with obvious advantages in terms of work cycle productivity.

Furthermore, the cutting unit, unloaded, for example, of the components needed for drilling or other processing, is lighter and therefore more efficient.

In some embodiments, the machine 1 is provided with position sensors suitable for providing the electronic control unit 30 with information on the position of the flat piece relative to the first and second areas A1, A2 of the cutting mat 12. In this way, for example, when a portion of the flat piece subjected to accessory processing enters the second area A2, the electronic control unit 30 actuates the accessory processing unit 20.

In one embodiment, the machine 1 comprises a mat actuator—not shown—controllable by the electronic control unit 30 for the automatic translation of the cutting mat 12 on the cutting table 10.

In one embodiment, the electronic control unit 30 is programmed to drive the mat actuator in such a way that the translation of the cutting mat 12 occurs intermittently, i.e., in steps.

In a variant embodiment, the electronic control unit 30 is programmed to drive the mat actuator so that the translation of the cutting mat 12 occurs continuously. In this case, the cutting unit 14 and the accessory processing unit 20 are controllable so as to make the cut and perform the accessory processing during the translation of the cutting mat 12.

More specifically, in one embodiment, in the part programs of the processing operations there are interchange commands between the two controllers, of the cutting unit and the accessory processing unit, which allow synchronization of the processing operations at any time; these commands may actuate certain functions in both the cutting unit and the accessory processing unit.

Therefore, during accessory processing, the machine may make the cut of a figure while the cutting mat 12 is in motion. At the same time, the accessory processing unit may perform an operation, e.g., labeling, drilling, die cutting, on another previously cut part, again while the cutting mat 12 is in motion.

In an embodiment illustrated in FIG. 2, the synchronization of the cutting unit 14 and the accessory processing unit 20 with the movements of the cutting mat 12 uses continuous detection of the position of the cutting mat, for example obtained from an encoder 122 or other mat position sensor placed inside the cutting mat. The position of the cutting mat 12 is continuously transmitted to the electronic control unit 30 (or simultaneously to the cutting unit controller and the accessory processing unit controller).

For example, assuming that the accessory processing unit moves in a space defined by the three orthogonal axes X, Y, Z, where X is the translation axis of the cutting mat 12 (coincident with the advancement direction T), the control unit 30 is programmed to link the coordinate xⱼ of the accessory processing unit to the position of the cutting mat 12 along the axis X. In practice, when processing is to be performed by the accessory processing unit, the programmed coordinates yⱼ and zⱼ, i.e., the coordinates along the axes orthogonal to the translation axis X of the cutting mat 12, remain unchanged, while the coordinate xⱼ is continuously updated in the control of the accessory processing unit with the difference x_{j,w}=xⱼ−w, where xⱼ is the coordinate along the programmed axis X and w is the actual position of cutting mat 12.

In other words, the electronic control unit 30 is programmed to acquire from the mat position sensor the current position w of the cutting mat 12 and to command the cutting unit 14 and the accessory processing unit 20 to follow a cutting and accessory processing path. The path coordinates x_{i,w}; x_{j,w} along the mat translation axis X are given by the difference between predetermined coordinates xᵢ; xⱼ and the current position w of the cutting mat 12.

In one embodiment, the cutting path is described in a CAD file that also includes a description of the accessory processing. The electronic control unit 30 receives this CAD file and, using the coordinates of the cutting path and the accessory processing path, provides command instructions for the actuation of the cutting unit 14 and the accessory processing unit 20.

As mentioned above, in the case of processing carried out during the translation of the cutting mat, the coordinates of the cutting path and the accessory processing path along the mat translation axis X are changed in real time by the electronic control unit 30 according to the position of the cutting mat, i.e., its elevation along the translation axis X with respect to an initial reference elevation.

In one embodiment, the second area A2 of the cutting mat is defined downstream or upstream of the first area A1 of the cutting mat in the advancement direction (T) of the flat piece.

More precisely, in the case wherein the portion of the cutting table engaged by the cutting mat 12 has a rectangular area, in an embodiment illustrated in FIG. 1b the first and second areas are two rectangular portions that are substantially consecutive and adjacent. In other words, the first and second areas are two partitions of this rectangular area of the cutting mat 12.

As mentioned above, in one embodiment the accessory processing unit 20 is a unit for drilling and/or die cutting the flat piece.

Described below is a particular drilling and die cutting unit 20, which, being released from the cutting unit 14, may be designed to make holes on the flat piece, even of different diameters, very accurately and quickly.

In one embodiment, the drilling and/or die cutting unit 20 comprises a robotic arm 24 placed downstream or upstream of the cutting unit 14 along the advancement direction (T) of the flat piece on the cutting table. An electromechanical member 26 suitable for operatively supporting a drill bit or die cutting bit 22 is mounted on the wrist 24′ of the robotic arm 24.

For example, the robotic arm 24 is supported by an arm beam 28 fixed to the cutting table 10 and extending between opposite sides thereof, perpendicular to the advancement direction (T) of the flat piece.

In an alternative embodiment, the robotic arm 24 may also be attached to a structure above the cutting machine 1.

In one embodiment, the electromechanical member 26 comprises a toroidal-shaped motor assembly 300 (also known as a “torque” motor), i.e., which extends coaxially around a motor rotation axis. The motor assembly 300 is provided with means for coupling to the drill bit or die cutting bit 22.

In one embodiment, these coupling means are suitable

for supporting the drill bit or die cutting bit 22 coaxially to the motor rotation axis. In other words, advantageously, it is possible to mount the motor assembly 300 on the wrist 24′ of the robotic arm 24 in such a way that the motor rotation axis is oriented vertically, thus coaxially with the direction of insertion of the drill bit or die cutting bit 22 into the flat piece.

In one embodiment, the motor assembly 300 is attached to the lower end of a helical rod 32 supported by the wrist 24′ of the robotic arm 24 in such a way that its rotation, controlled by a wrist motor housed in the wrist 24′, corresponds to its translation in the vertical direction, and consequently to a movement in the vertical direction of the motor assembly 300 and thus of the drill bit or die cutting bit 22 attached thereto.

FIGS. 4b and 5 show an example of a tool assembly 40 comprising a drill bit or die cutting bit 22. The die cutting bit differs from the drill bit in that it consists of a hollow tubular body ending in a sharp edge.

The drill bit and die cutting bit 22 end at the top with a ring gear 222 suitable for rotationally coupling with a corresponding ring gear of the rotor of the motor assembly 300.

Each drill bit or die cutting bit 22 is rotatably supported by a tool holder plate 42 to which a conical body 44 is attached that houses ball bearings 46 (or equivalent means of rotating support) for rotating the drill bit or die cutting bit 22. The upper portion of the drill bit or die cutting bit, bearing the ring gear 222, protrudes above this conical body 44. The conical body 44 is suitable for coupling geometrically with the lower part of the body of the motor assembly 300.

In one embodiment, once the motor assembly 300 is in contact with the conical body 44 of the tool holder plate 42, a rotation of the helical rod 32, and thus of the body of the motor assembly 300, causes the axial locking between the motor assembly 300 and the conical body 44. For example, this rotation of the helical rod 32 is 45°. As a result of this rotation, one or more locking pins or balls or other radial locking means supported by the motor assembly 300 engage corresponding recesses obtained in a collar 44′ extending from the top of the conical body 44.

In a variant embodiment, the body of the motor assembly 300 comprises or supports pneumatic coupling means, for example in the form of a gripper, suitable for providing the coupling between the motor assembly 300 and the tool assembly 40.

At the bottom, the drill bit or die cutting bit 22 is guided slidingly into a lower piece support plate 48. This lower plate 48 is elastically connected to the tool holder plate 42, for example by means of a pair of elastic elements 50, such as helical springs wound on respective side guide columns 52. The lower plate 48 is suitable for resting on the flat piece, holding it in place, when the drill bit or die cutting bit 22 descends to drill through the flat piece.

In one embodiment, the tool holder plate 42 forms an anchor extension 42′ suitable for being coupled to a support bracket 54 for the tool assembly 40.

In one embodiment, the support bracket 54 for the tool assembly 40 is mounted on the arm beam 28 that supports the robotic arm 24.

Therefore, the arm beam 28 also serves as a tool holder magazine to support tool assemblies 40 with drill or die cutting bits 22 of different diameters.

In one embodiment illustrated particularly in FIG. 4b, the robotic arm 24 comprises an ejector rod 60 translatable in the die cutting bit 22 to eject the cut material in the die cutting bit 22.

In one embodiment, the ejector rod 60 is connected to a piston rod 62 of a pneumatic cylinder 64 mounted on top of the helical rod 32. In this embodiment, the helical rod 32 is hollow and slidingly accommodates the piston rod 62.

In other embodiments, the ejector-motor-drilling tool assembly does not work coaxially with the helical rod of the robot, but may be fixed thereto with side brackets and thus work in an “offset” manner.

In a variant embodiment, the accessory processing unit 20 is a labeling unit suitable for pasting a label onto the polygonal shapes cut by the cutting unit 24.

Also in this case, the labeling unit may comprise a robotic arm, on the wrist of which a label pick-up tool is mounted, such as a suction cup or a system based on the Venturi effect.

The present invention also pertains to a method for making a cut in closed shapes and/or along lines according to a predetermined cutting path on at least one flat piece made of deformable material and accessory processing by means of an automatic cutting machine 1 as described above.

The method provides for advancing the flat piece from the loading area to the unloading area, for example by actuating the cutting mat 12 if it is of a conveyor belt type.

When the flat piece is exclusively within the first area (A1) or second area (A2) of the cutting mat, the cutting unit 24 or the accessory processing unit 20 is actuated, respectively.

On the other hand, when the flat piece is at least partially within both the first and second areas (A1, A2) of the cutting mat, the electronic control unit 30 simultaneously actuates both the cutting unit 14 and the accessory processing unit 20.

In one embodiment, the accessory processing is drilling or die cutting of the flat piece or labeling of the shapes or figures obtained from cutting the flat piece.

In one embodiment, the cutting path is described in a CAD file that also includes a description of the accessory processing.

In this case, the method involves acquiring, by an electronic control unit of the cutting machine, said CAD file.

The electronic control unit 30 then transmits the coordinates of the cutting path to the electric drives of the cutting unit 14 and the coordinates of the accessory processing to the electric drives of the accessory processing unit 20.

In one embodiment, the translation of the cutting mat occurs continuously, and the cutting unit and the processing unit perform the cut and the accessory processing during the translation of the cutting mat. The electronic control unit calculates the coordinates of the cutting path and the path of the accessory processing unit along the mat translation axis X as the difference between predetermined coordinates and the current position of the cutting mat.

In the case of drilling/die cutting units, the software defines which tool should be used to make the first hole.

The robotic arm 24 is commanded to proceed with the coupling of a tool assembly 40.

In particular, the helical rod 32 is placed with the motor assembly 300 above the tool assembly 40; the helical rod 32 is commanded to descend to a position defined by the coupling between the conical body 44 of the tool holder plate and the body of the motor assembly 300. At this point the means for coupling to the tool assembly are actuated. For example, the helical rod 32 is rotated, for example by an angle of 45°, to provide the coupling between the motor assembly 300 and the tool assembly 40. In other embodiments, as mentioned above, pneumatic coupling means, such as in the form of a gripper, are actuated to clamp and lock the tool assembly 40.

Once the tool assembly 40 is coupled, the robotic arm 24 is commanded to bring the tool assembly 40 to the position at which a hole is to be drilled in the flat piece.

The method for making a hole by die cutting is as follows.

The rotation of the motor assembly 300 is started, which also rotates the die cutting bit 22 accordingly; the helical rod 32 descends, causing the cutting edge of the die cutting bit 22 to penetrate the material of the flat piece, for example by bringing it about one centimeter beyond the thickness of the material being processed. After a predetermined time interval, such as half a second, the helical rod 32 is returned to the inactive raised position. During this step of lifting the helical rod 32, the ejector cylinder 64 placed above the helical rod 32 is actuated. The cylinder 64 actuates the relevant piston 62 and then the ejector rod 60 connected thereto, causing the cut material to be discharged from the die.

Drilling a hole by means of a drill bit is done in the same way, with the only difference (besides the higher RPM of the torque motor) being that the ejector rod 60 remains in an idle raised position since there is no cut material inside the drill bit.

The processing cycle involves drilling all holes in sequence where the same die or drill bit is required, otherwise a tool change is performed.

If a tool change is required, the robotic arm 24 is commanded to position itself over an empty tool assembly's 40 support bracket 54. The helical rod 32 descends until the coupling extension 42′ of the tool holder plate 40 couples with the support bracket 54. At this point, the motor assembly 300 may be disengaged from the tool assembly 40, for example through a 45° rotation of the helical rod 32. This helical rod is then lifted and repositioned on top of a tool assembly 40 to be coupled using the procedure described above.

In the case of labeling, the machine's control software sends the part code to be printed to a printer. The label is prepared.

The robotic arm engages the tool, such as suction cup, to pick up the label.

The wrist of the robotic arm positions itself over the printed label and engages it.

The robotic arm is commanded to position itself over the piece to be labeled and descends to release the label; the label, as it is adhesive, remains attached to the piece.

FIG. 6 is a flowchart example 500 of the control program of the drives of the cutting unit and of the robot which moves the accessory processing unit, in one embodiment.

When the process has started, the electronic control unit 30 sends work programs to the cutting unit and to the robot (step 502).

The cutting unit 14 starts the cutting operation (step 503).

In one embodiment, the cutting mat 12 (step 504) is commanded to advance.

The program checks whether there are any figures to be cut during the advancement of the cutting mat (step 506).

If so, the cutting unit continues cutting (step 508).

Otherwise, the cutting unit waits for a figure to enter the work area (step 510).

After a figure has been cut, the program checks whether there are still figures to be cut that have not yet entered the cutting area (step 512).

If so, the cutting mat is commanded to advance (step 504), and it proceeds to step 506 to check whether there are figures to be cut during the advancement of the cutting mat.

Otherwise, the cutting operation control program ends (step 514).

As the cutting mat 12 advances, the program checks whether the figures enter the robot's work area (step 516).

If so, the robot is commanded to perform the processing of the available figures (step 518).

Otherwise, the program waits for a figure to enter the robot's work area (step 520).

When the robot has finished processing a figure, the program checks whether there are still figures to be processed that have not entered the robot's work area (step 522).

If so, the cutting mat is commanded to advance (step 504), and it proceeds with step 516 to check whether there are figures to be processed during the advancement of the cutting mat.

Otherwise, the processing control program of the robot ends (step 524).

The cutting machine according to the invention may also be used to perform other accessory processing in addition to the drilling and labeling described above.

For example, the tool of the accessory processing unit may be a printhead suitable for printing information directly in the cartene provided at the top of the closed shape to replace the labeling operation.

In another embodiment, the accessory tool may be a fixed or ultrasonic blade, suitable for generating small cuts on the contours of closed shapes that are used as reference points between the various shapes in the subsequent post-cutting assembly step.

In addition to the fixed blade, a die may be used with “V” shapes of various angles that create “V”-shaped references in place of simple cut-outs, so they are more visible than simple cut-outs to the assembler operator.

In order to meet contingent needs, a person skilled in the art may make to the embodiments of the cutting machine and of the method according to the of invention changes, adaptations, and replacements elements with others that are functionally equivalent, without departing from the scope of the following claims. Each of the features described as belonging to a possible embodiment may be obtained independently of the other described embodiments.

What is claimed is:

1. A cutting machine for the automated cutting of at least one flat piece made of deformable material, comprising:
a cutting table which supports a cutting mat and extends between a loading area of the flat piece onto the cutting mat and an unloading area of the flat piece from the cutting mat, the flat piece being translatable on or with the cutting mat from the loading area to the unloading area;
a cutting unit provided with a blade and movable over the cutting mat to cut the flat piece into shapes and/or along lines according to a predetermined cutting path;
an accessory processing unit provided with at least one accessory tool and movable over at least a portion of the cutting mat to perform accessory processing of the flat piece according to a predetermined accessory processing path;
an electronic control unit configured to control the cutting unit and the accessory processing unit, the electronic control unit being programmed so as to actuate the accessory processing unit simultaneously to the cutting unit at least during a cutting step of the flat piece;
wherein the electronic control unit is configured to move the cutting unit within a first area of the cutting mat and move the accessory processing unit within a second area of the cutting mat, and wherein the second area coincides with the first area or the second area is within the first area or the second area at least partially overlaps the first area.

2. A machine according to claim 1, wherein the electronic control unit is programmed to actuate the accessory processing unit simultaneously to the cutting unit when the flat piece at least partially enters the second area of the cutting mat.

3. A machine according to claim 1, comprising a mat actuator controllable by the electronic control unit to perform an automated translation of the cutting mat on the cutting table.

4. A machine according to claim 3, wherein the electronic control unit is programmed to actuate the mat actuator so that the translation of the cutting mat occurs in an intermittent manner.

5. A machine according to claim 3, wherein the electronic control unit is programmed to actuate the mat actuator so that the translation of the cutting mat occurs continuously, the cutting unit and the accessory processing unit being controllable so as to make the cut and perform the accessory processing during the translation of the cutting mat, wherein the machine comprises a mat position sensor suitable for continuously sensing the position of the cutting mat along the translation axis, and wherein the electronic control unit is programmed to acquire from the mat position sensor the current position of the cutting mat and to command the cutting unit and the accessory processing unit to follow a cutting and accessory processing path, wherein the coordinates of said path along the mat translation axis are given by the difference between predetermined coordinates and the current position of the cutting mat.

6. A machine according to claim 1, wherein the accessory processing unit is a unit for drilling and/or die cutting the flat piece.

7. A machine according to claim 6, wherein the drilling and/or die cutting unit comprises a robotic arm placed downstream or upstream of the cutting unit along the advancement direction of the cutting mat on the cutting table, wherein an electromechanical member suitable for operatively supporting a drill bit or a die cutting bit is mounted on the wrist of the robotic arm.

8. A machine according to claim 7, wherein said electromechanical member comprises a toroidal-shaped motor assembly which extends around a motor rotation axis and which is provided with coupling means to the drill bit or die cutting bit, said coupling means being suitable for supporting the drill bit or the die cutting bit coaxially to said motor rotation axis.

9. A machine according to claim 7, wherein the robotic arm comprises an ejection rod which is translatable inside the die cutting bit to eject the cut material inside the die cutting bit.

10. A method for making a cut in closed shapes and/or along lines according to a predetermined cutting path on at least one flat piece made of deformable material, and accessory processing by means of an automatic cutting machine comprising:
a cutting table which supports a cutting mat and extends between a loading area of the flat piece onto the cutting mat and an unloading area of the flat piece from the cutting mat, where the flat piece is translatable on or with the cutting mat from the loading area to the unloading area;
a cutting unit provided with a blade and movable over a first area of the cutting mat to cut the flat piece
an accessory processing unit provided with at least one accessory tool and movable over a second area of the cutting mat to perform accessory processing of the flat piece, wherein the second area coincides with the first area (A1) or the second area is within the first area (A1) or the second area at least partially overlaps the first area (A1);
the method comprising the steps of:
advancing the flat piece from the loading area to the unloading area;
simultaneously actuating both the cutting unit and the accessory processing unit at least during a cutting step of the flat piece.

11. A method according to claim 10, further comprising the steps of:
when the flat piece is exclusively in the first or second area of the cutting mat, actuating either the cutting unit or the accessory processing unit;
when the flat piece is at least partially in both the first and the second area of the cutting mat, simultaneously actuating both the cutting unit and the accessory processing unit.

12. A method according to claim 10, wherein the accessory processing is drilling or die cutting of the flat piece or labelling of the shapes obtained from cutting the flat piece.

13. A method according to claim 10, wherein the cutting path is described in a CAD file which also includes a description of the accessory processing, the method comprising the steps of:
acquiring, by an electronic control unit of the cutting machine, said CAD file;
transmitting, by the electronic control unit, the coordinates of the cutting path to electric drives of the cutting unit and the coordinates of the accessory processing to electric drives of the accessory processing unit.

14. A method according to claim 10, wherein the flat piece is advanced in an intermittent manner.

15. A method according to claim 10, wherein the flat piece is advanced continuously, wherein the cutting unit and the accessory processing unit are controlled so as to perform the cut and the accessory processing during the translation of the cutting mat, the method further comprising the steps of:
acquiring from a mat position sensor the current position (w) of the cutting mat;
acquiring the coordinates of the cutting path (xᵢ, yᵢ, zᵢ) and the coordinates of the accessory processing path (xⱼ, yⱼ, zⱼ);
calculating updated coordinates of the cutting path and the accessory processing path, wherein the coordinates (x_{i,w}, x_{j,w}) of the cutting path and the accessory processing path along the translation axis (X) of the cutting mat are obtained from the difference between the acquired coordinates (xᵢ, xⱼ) and the current position (w) of the cutting mat;
transmitting to the cutting unit and the accessory processing unit the updated coordinates of the cutting path and of the accessory processing path.

16. A method according to claim 10, wherein the second area of the cutting mat is defined downstream or upstream of the first area of the cutting mat in the advancement direction of the flat piece from the loading area to the unloading area.

17. (canceled)
